(19) United States
(12) Patent Application Publication
(10) Pub. No.: US 2010/0002533 A1
(43) Pub. Date: Jan. 7, 2010

(54) STIRRING ASSEMBLY WITH A STIRRING ELEMENT AND A GASSING DEVICE

(75) Inventor: Werner Himmelsbach, Rheinfelden (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: EKATO Rühr-und Mischtechnik GmbH, Schopfheim (DE)

(21) Appl. No.: 12/517,309

(22) PCT Filed: Jan. 10, 2008
(86) PCT No.: PCT/DE08/00030

§ 371 Date: Jun. 2, 2009

(30) Foreign Application Priority Data
Jan. 11, 2007 (DE) 10 2007 001 711.3

(51) Int. Cl. B01F 13/02

(52) U.S. Cl. 366/102

(57) ABSTRACT

The invention relates to a stirring assembly comprising a stirring element (2) for stirring a liquid and a gassing device (3 or 3′) which supplies gas, such as air, below the stirring element (2) and at the side(s) of the stirring element (2), with the gas to be dispersed by means of the stirring element (2). The gassing device (3; 3′) is designed in such a manner that until a critical gas quantity value determining the flooding point is reached, the gassing device (3; 3′) supplies the quantity of gas to the stirring element (2) from below and when the flooding point is exceeded, the gassing device (3; 3′) simultaneously supplies the gas exceeding the flooding point at the side(s) of the stirring element (2). The aim of the invention is to prevent the stirring element (2) from being flooded and to improve the dispersing effect of the liquid and gas.; For this purpose, the gas supply in the stirring assembly according to the invention is carried out, depending on the quantity of gas to be supplied, from below and from the side(s) in relation to the stirring element (2).

The invention relates to a stirring assembly with a stirring element for stirring a liquid and a gassing device which supplies a gas, such as air, below the stirring element or at a side of the stirring element, wherein the gas is to be dispersed by the stirring element.

EP 0 847 799 A1 describes a stirring element which is used, in particular, as a gassing-stirring element for stirring liquids. A gas, for example air, is supplied to the liquids. In this gassing-stirring element, the gas is supplied through a supply pipe, whose mouth is located below the stirring axis of the stirring element.

As an alternative to the gas supply pipe, a ring-shaped gas distributor, a so-called ring shower, can be arranged below the stirring element, wherein the ring shower has several openings distributed along the periphery, through which the gas supplied to the stirring element can exit.

It has been found that when using a gassing-stirring element of this type, the stirring element can no longer disperse the total quantity of the supplied gas when a critical gas quantity value is exceeded, which is also referred to as flooding point. When this flooding point is exceeded, a portion of the gas supplied through the gassing device rises to the surface in form of large bubbles and no longer participates in the mass transfer to the liquid. The stirring element can then also no longer provide an adequate pumping action, causing intermixing of liquid and gas to deteriorate. This is disadvantageous, in particular, with continuously operating reactors employing this type of gassing-stirring element, and any existing solid particles already present can then partially settle on the bottom.

These difficulties when exceeding the flooding point can be overcome by designing the gassing device such that the gas is supplied from one location located at the side and radially outside the stirring element. Gas can be supplied from the side by arranging one or several pipes in the circumferential direction; alternatively, a ring shower can be arranged outside the stirring element. Flooding of the stirring assembly can thereby be prevented, while maintaining the mixing and suspending effect. However, this results in a less favorable dispersing effect with a smaller mass transfer than if the gas were supplied from outside the stirring element, when such stirring arrangement is operated below the flooding point.

It is an object of the invention to provide a stirring assembly with a stirring element and a gassing device which helps prevent flooding with large gas quantities and at the same time also optimizes mass transfer.

According to the invention, a stirring assembly with a stirring element for stirring liquids and a gassing device are provided, which supply a gas, for example air, to be dispersed by the stirring element below the stirring element or at a side of the stirring element, wherein the stirring assembly is characterized in that the gassing device is constructed such that the gassing device supplies the gas to the stirring element from below until a critical gas quantity value is reached which determines the flooding point, and that when the flooding point is exceeded, the gassing device supplies the gas quantity that exceeds the flooding point simultaneously from the side.

With the design of the stirring assembly according to the invention, the gassing device operates by intentionally controlling the supplied gas quantity depending on the flooding limit value, in that the gas quantity is supplied to the stirring element below the stirring element when operating below the flooding limit value, and in that when the flooding limit is exceeded, the gas quantity exceeding the flooding limit is additionally supplied to the gassing device at the side of the stirring element. The design of the stirring assembly according to the invention thereby allows control of the gas supplied to the stirring element depending on the flooding limit or the flooding point or the flooding limit value. This approach prevents flooding of the stirring element and hence also eliminates the associated disadvantages and problems, while achieving overall an optimized dispersing effect even for large gas quantities, i.e., those gas quantities which exceed the critical gas quantity value of the flooding point. The stirring assembly according to the invention therefore provides with the gassing device a separate or divided gas supply, depending on the gas quantities to be supplied and to be dispersed.

According to a preferred embodiment according to the invention, the gassing device for supplying gas below and at the side of the stirring element may be formed by at least one or several pipes. In this embodiment, gas is supplied via the gassing device by one or more pipes which are axially and radially spaced from the stirring element.

In an alternative embodiment of the stirring assembly, the gassing device for supplying gas below and at the side of the stirring element may be formed by a ring shower. In this embodiment, ring-shaped gas distributors are employed, which are radially and axially spaced from the stirring element and which have suitable openings through supplying the gas to the rotating stirring element.

In another embodiment according to the invention, additional embodiments may advantageously include combinations of one or several pipes and ring showers, wherein the gassing device on the whole is configured such one or several pipes, which are axially spaced from the stirring element, or a ring shower are provided for supplying gas from below, whereas for supplying the gas with the gassing device at the side either one or several pipes which are radially spaced from the stirring element or a ring shower which is radially spaced from the stirring element are provided.

The axial and/or radial positions of the pipe(s) or the ring shower(s) can vary within certain limits. This is more closely described with reference to the outside diameter of the stirring elements and its center axis in claims 5 and 6.

In summary, it is important with the stirring assembly of the invention that the gassing device distributes the gas depending on the supplied gas quantity so that a portion of the total gas quantity, namely the quantity below the flooding limit, is supplied to the stirring element from below, whereas the remaining gas quantity is supplied to the stirring element from the side, in order to effectively prevent flooding of the stirring element of the stirring assembly and to ensure optimal mass transfer from the gas to the liquid during dispersion.

Preferred embodiments of the invention will now be described with reference to the appended drawings, which are to be taken as examples only and are not intended to limit the scope of the invention.

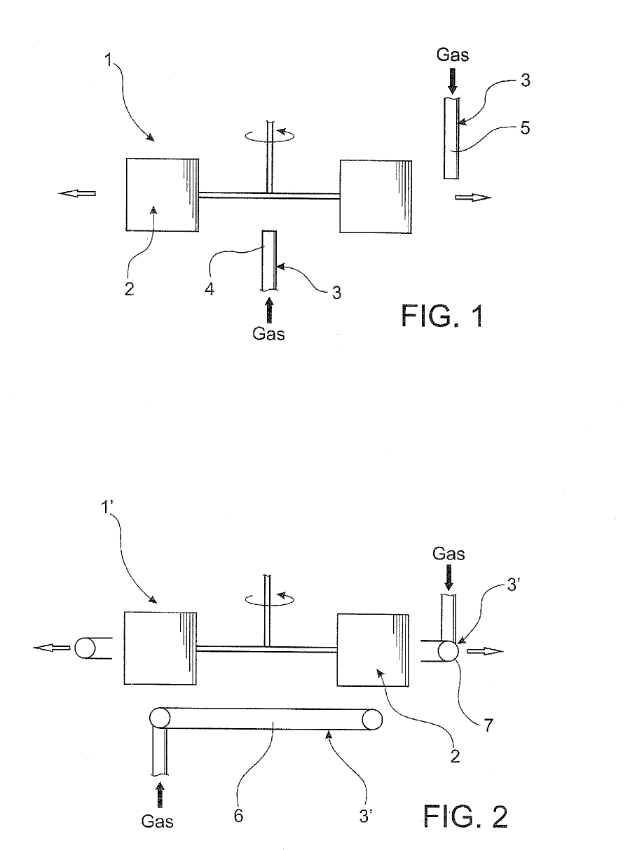

FIG. 1 shows schematically in a side view a stirring assembly with a stirring element and a gassing device according to the invention,

FIG. 2 shows schematically in a side view a modified embodiment of a stirring assembly with a stirring element and a gassing device according to the invention,

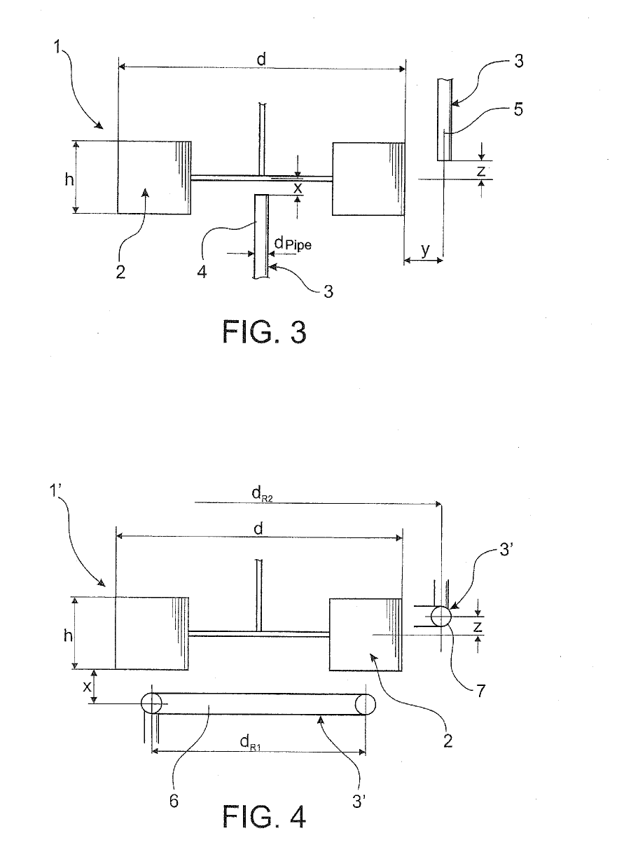

FIG. 3 illustrates preferred range designations and their association with the stirring element and the gassing device in the embodiment of FIG. 1, and

FIG. 4 illustrates preferred range designations and their association with the stirring element and the gassing device in the embodiment of FIG. 2.

In the following description of the preferred embodiments, identical and similar elements are designated with the same reference symbol.

FIG. 1 shows a first embodiment of a stirring assembly designated in general with reference numeral 1. The stirring assembly 1 includes a stirring element shown in a schematic diagram and designated with the reference numeral 2, which is constructed in a manner described in more detail in EP 0 847 799 A1. The stirring arrangement 1 also includes a gassing device designated with the numeral 3, which in the example illustrated in FIG. 1 is configured so that the gas to be dispersed with the stirring element 2 is supplied to the stirring element 2 from below, with a spacing from the axis, through one or several pipes 4, of which only one is shown in FIG. 1. Also schematically indicated are one or several pipes 5, through which the gassing device 3 supplies at least a portion of the supplied gas flow to the stirring element 2 at the side with a radial spacing. An arrow schematically indicates the rotation direction of the stirring element 2, whereas a double arrow schematically indicates the outflow direction from the stirring element 2.

The stirring assembly shown in FIG. 1 is constructed so that the gassing device 3 supplies a gas, such as air, through the pipe(s) 4 with an axial spacing from the bottom side of the stirring element 2, until a critical gas quantity is reached which represents the flooding point or the flooding limit, where the supplied gas quantity participates in the mass transfer in the dispersion region of the stirring element. When the supplied gas quantity exceeds the flooding limit of the stirring element 2, the gas quantity exceeding the flooding limit is additionally supplied through one or several pipe(s) 5 with a radial spacing from the stirring element 2 at the side of the stirring element 2, so that flooding of the stirring element 2 is effectively prevented in the stirring assembly shown in FIG. 1 and a gas quantity exceeding the flooding limit is optimally supplied to the stirring element 2 for dispersing the liquid.

FIG. 2 shows a stirring assembly designated with the overall reference numeral 1′ which, like in FIG. 1, includes a stirring element 2. In the embodiment of FIG. 2, the gassing device 3′ is constructed so that the gas is supplied from below the stirring element 2 as well as at the side of the stirring element 2 through a ring-shaped gas distributor 6 and a ring-shaped gas distributor 7 which has openings through which the gas can be supplied to the rotating stirring element 2. These ring-shaped gas distributors 6, 7 also referred to as ring showers.

The rotation direction of the stirring element 2 is indicated in both FIG. 1 and FIG. 2 by an arrow, whereas the outflow direction of the stirring element 2 is indicated by a double arrow. The gassing device 3′ according to FIG. tool is also configured such that up to the flooding limit the gas quantity is supplied to the stirring element 2 with an axial spacing through the ring shower 6, and that the gas quantity exceeding the flooding limit is additionally supplied to the stirring element 2 through the ring shower 7 at the side with a radial spacing.

Although not shown in detail, the pipes 4 and 5 and the ring showers 6 and 7 can also be combined when designing the gassing device 3 and 3′, respectively. For example, a pipe 4 may supply the gas from below, and several types 5 arranged at the side and distributed along the periphery may be associated with the stirring element 2 for supplying the gas from the side. Alternatively, the gassing device 3, 3′ may also be configured such that the gas is supplied via a ring shower 6 partially from below, while the gas is supplied at the side through one or several pipes 5 which are distributed along the periphery. Alternatively, one or several pipes 4 may supply the gas to the stirring element 2 from below, whereas a ring-shaped gas distributor or a ring shower 7 is provided for supplying the gas from the gassing device 3, 3′ at the side. The specific designs of the gassing device 3, 3′ and of the corresponding supply devices from below and at the side may be selected by taking into consideration the particular situation and the specific operating conditions.

Preferred relationships of the design criteria of the gassing device 3 of FIG. 1 in the stirring assembly 1 according to FIG. 1 will now be described in more detail with reference to FIG. 3. The outside diameter of the stirring element 2 is designated with d; h is the axial height of the stirring element 2, whereas dₚᵢₚₑ designates a diameter of the pipe 4 in FIG. 1. An axial distance x from the center axis of the stirring element 2 is in the range of x=(0.1-5) dₚᵢₚₑ, and a preferred range is x=(0.2-1) dₚᵢₚₑ. A radial distance y measured from the center axis of the pipe 5 to the outside contour of the stirring element 2 for supplying gas from the gassing device 3 at the side in FIG. 1 is in a range of y=(0.03-0.5)d and preferably in a range of y=(0.05-0.2)d. An axial distance z between the center axis of the stirring element 2 at the opening of the pipe 5 and the gas supply at the side is preferably in a range of z=±(0-1)h, and preferably in a range of z=±(0-0.75)h.

FIG. 4 describes the geometric relationships between the gassing device 3′ and the stirring element 2 in the example of FIG. 2. h again indicates the axial height of the stirring element 2 in FIG. 4. d designates the outside diameter of the stirring element 2. A diameter d_{R1} of the ring shower 6 for the bottom gas supply is preferably in a range of d_{R1}=(0.3-1.2)d, with d_{R1} preferably in a range of d_{R1}=(0.5-1)d. An axial distance x at the bottom side of the stirring element 2 may be in a range of x=(0.03-0.5)d, preferably in a range of x=(0.05-0.2)d. An average diameter d_{R2} of the ring shower 7 for the gas supply from the gassing device 3′ at the side may be in a range of d_{R2}=(1.05-2)d and preferably in a range of d_{R2}=(1.1-1.5)d. z designates an axial distance z between the center axis of the ring shower 7 in FIG. 2 and the center axis of the stirring element 2. This axial distance can be in a range of z=±(0-1)h and preferably in a range of z =±(0-0.75)h.

It will be understood that these examples and range values are approximate values and not absolute quantities.

It is also understood that the invention is not limited to the aforedescribed examples and details described with reference to the preferred embodiments, but that many changes and modifications are possible which can be, if necessary, and for special applications determined by suitable experiments. An important attribute of the stirring assembly 1, 1′ according to the invention is that the gas is supplied from below and at the side of the stirring element 2 in such a way that the gas is supplied from the bottom side of the stirring element 2 approximately to the flooding limit of the stirring element 2, whereas the gas quantity exceeding the flooding limit is additionally supplied from the gassing device 3, 3′ to the stirring element 2 at the side.

1-6. (canceled)

7. A stirring assembly comprising
a stirring element for stirring a liquid; and
a gassing device which supplies a gas from below the stirring element until a critical gas quantity value which determines a flooding point is reached, and which above the flooding point supplies the gas that exceeds the flooding point also at a side of the stirring element, wherein the gas is dispersed by the stirring element.

8. The stirring assembly of claim 7, wherein the gassing device for supplying gas from below and at the side of the stirring element is formed by at least one pipe.

9. The stirring assembly of claim 7, wherein the gassing device for supplying gas from below and at the side of the stirring element is formed by a ring-shaped gas distributor or a ring shower.

10. The stirring assembly of claim 7, wherein the gassing device for supplying gas from below the stirring element is formed by at least one pipe or by a ring shower and the gas is supplied at the side of the stirring element either through a ring shower or at least one pipe.

11. The stirring assembly of claim 8, wherein an axial distance x of a opening of the at least one pipe from a center axis of the stirring element is in a range of x=(0.1-5) d_{Pipe}, wherein d_{Pipe} is a diameter of the at least one pipe, a radial distance y of a center axis of the at least one pipe from an outside contour of the stirring element is in a range of y=(0.03-0.5)d, wherein d is an outside diameter of the stirring element, and an axial distance z to a radial center axis of the stirring element at the opening of the at least one pipe is in a range of z=±(0-1)h, wherein h is an axial height of the stirring element.

12. The stirring assembly of claim 11, wherein the axial distance x of the opening of the at least one pipe from the center axis of the stirring element is in a range of x =(0.2-1) d_{Pipe}.

13. The stirring assembly of claim 11, wherein the radial distance y of the center axis of the at least one pipe from the outside contour of the stirring element is in a range of y=(0.05-0.2)d.

14. The stirring assembly of claim 11, wherein the axial distance z to the radial center axis of the stirring element at the opening of the at least one pipe is in a range of z=±(0-0.75)h.

15. The stirring assembly of claim 9, wherein an average diameter d_{R1} of the ring shower for supplying gas from the bottom is in a range of d_{R1}=(0.3-1.2)d, wherein d is an outside diameter of the stirring element, an axial distance x between the gassing device and a bottom side of the stirring element is in a range of x=(0.03-0.5)d, an average diameter d_{R2} of the ring shower for supplying gas from the gassing device at the side is in a range of d_{R2}=(1.05-2)d, and an axial distance z between a center axis of the stirring element and a center axis of the ring shower is in a range of z=±(0-1)h, wherein h is an axial height of the stirring element.

16. The stirring assembly of claim 15, wherein the average diameter d_{R1} of the ring shower is in a range of d_{R1}=(0.5-1)d.

17. The stirring assembly of claim 15, wherein the axial distance x between the bottom side of the stirring element and the gassing device is in a range of x=(0.05-0.2)d.

18. The stirring assembly of claim 15, wherein the axial distance z between the center axis of the stirring element and the center axis of the ring shower is in a range of z=±(0-0.75)h.
